(19) United States
(12) Patent Application Publication
(10) Pub. No.: US 2004/0053803 A1
(43) Pub. Date: Mar. 18, 2004

(54) Method for enhancing cleansing vehicles and cleansing vehicles utilizing such method

(75) Inventors: Jason Lye, Atlanta, GA (US); Teri Taylor Kish, Roswell, GA (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/242,815

(22) Filed: Sep. 13, 2002

(51) Int. Cl. C11D 3/00

(52) U.S. Cl. 510/392

(57) ABSTRACT

A method and composition for generating hydrogen peroxide within a cleansing composition includes the addition of at least one enzyme to a cleansing vehicle containing at least one donor substrate, wherein the enzyme catalyzes a chemical reaction to produce hydrogen peroxide upon exposure to a gaseous acceptor substrate.

### FIELD OF THE INVENTION

The present invention relates generally to methods for generating enhanced cleansing vehicles. More specifically, the present invention relates to methods for generating cleansing and bleaching agents in cleansing vehicles and such cleansing vehicles produced by such methods.

### BACKGROUND OF THE INVENTION

It is widely known in the cleansing field that hydrogen peroxide can be used as a whitener, brightener, cleaner, antimicrobial agent, and oxidizer. Furthermore, the presence of hydrogen peroxide within a cleansing vehicle can improve the cleansing efficacy of the vehicle. It is thus desirable to incorporate hydrogen peroxide into cleansing products for both “bodily” cleansing (such as for example in toothpaste, mouthwash, and skin cream) and for “inanimate object” cleansing (such as in laundry detergent, surface cleaners, and carpet cleaners). However, due to the instability of hydrogen peroxide, for instance, as a result of ultraviolet light exposure (UV light), the shelf life of a cleansing vehicle containing hydrogen peroxide would be limited, and therefore, merely combining hydrogen peroxide with a cleansing vehicle can negatively impact its cleansing efficacy. There is therefore a need for a method for increasing the shelf life of hydrogen peroxide within a cleansing vehicle, while such cleansing product is not in use.

Attempts have been made to incorporate hydrogen peroxide into a cleansing vehicle through the use of a side-by-side tubular structure that can mix hydrogen peroxide with the cleansing vehicle during end-use. Essentially, the hydrogen peroxide is dispensed from a side-by-side configuration with toothpaste, from separate stream compartments, into a single stream onto a tooth brush. However, such a packaging structure can be awkward, and can encounter problems associated with concurrent dispensing of cleansing materials. Further, the expense of such packaging can be prohibitive, and the hydrogen peroxide can still be subject to destabilization. Therefore, there is a further need in the art for generating hydrogen peroxide on demand, and at the time of usage, from a single stream dispenser.

It is also known in the art that bleaching actions through oxidation can be obtained by converting hydrogen peroxide into water. However, the efficacy of such bleaching action can be improved if the hydrogen peroxide is generated and then immediately converted to water.

Therefore, there is a need in the art for generating hydrogen peroxide within a cleansing vehicle as part of a bleaching action during a product's end-use, and for a targeted application. There is a further need in the art to generate hydrogen peroxide within a cleansing vehicle, and to immediately convert the hydrogen peroxide into water in order to obtain optimal bleaching properties. It is to such needs that the present invention is directed.

### SUMMARY OF THE INVENTION

A method for generating hydrogen peroxide within a cleansing composition includes the addition of at least one enzyme to a cleansing vehicle containing at least one donor substrate, wherein the enzyme catalyzes a chemical reaction to produce hydrogen peroxide upon exposure to a gaseous acceptor substrate.

In an alternative embodiment, a method for generating hydrogen peroxide within a cleansing composition includes the addition of at least one donor substrate, at least one enzyme, and at least one gaseous acceptor substrate to an aqueous cleansing vehicle, wherein the donor substrate is specific to the enzyme, wherein the acceptor substrate comprises oxygen or air, and wherein the enzyme catalyzes a chemical reaction to produce hydrogen peroxide upon exposure to the donor substrate and the gaseous acceptor substrate.

A cleansing composition includes a cleansing vehicle; at least one enzyme; and at least one donor substrate; wherein the at least one enzyme catalyzes a chemical reaction to produce hydrogen peroxide upon exposure to a gaseous acceptor substrate.

In an alternative embodiment a cleansing composition includes an aqueous cleansing vehicle; at least one enzyme; and at least one donor substrate; wherein the at least one donor substrate is specific to the at least one enzyme, and wherein the enzyme catalyzes a chemical reaction to produce hydrogen peroxide upon exposure to the donor substrate and a gaseous acceptor substrate.

### BRIEF DESCRIPTION OF THE DRAWINGS

FIG. 1 illustrates a schematic of the chemical reaction for generation of hydrogen peroxide in situ.

FIG. 2 illustrates a schematic of the chemical reaction for the generation of hydrogen peroxide in situ, and the subsequent conversion to water utilizing 4-chloro-1-naphthol (4CN) indicator as a peroxidase substrate to effect a color change.

FIG. 3 illustrates a schematic of the chemical reaction for the generation of hydrogen peroxide in situ and the subsequent conversion to water using ascorbate as a peroxidase substrate.

FIG. 4 illustrates a schematic of the chemical reaction for the generation of hydrogen peroxide in situ and the subsequent conversion to water utilizing a stain as a peroxidase substrate.

FIG. 5 illustrates a perspective view of an exemplary dispenser instrument for single stream dispensing a composition in accordance with the invention.

### DEFINITIONS

Within the context of this specification, each term or phrase below will include the following meaning or meanings.

“Vehicle” refers to a substance, mixture or material in which an enzyme may be added to perform a function. The substance or material can be, for example, in the form of an end-use product, a liquid cleansing composition or a work-in-process, such as an intermediary.

“Product's end-use” shall refer to that use which is normally associated with the product.

“Cleansing vehicle” refers to a class of vehicles utilized for such objectives as cleaning, whitening, brightening, and antimicrobial activity. The cleansing vehicle class can be further defined by the object to which they focus on cleaning. For instance, for the purposes of this application, cleansing vehicles can be further defined as “bodily” cleansing vehicles and “inanimate object” cleansing vehicles. “Bodily” cleansing refers to any type of cleansing vehicle that can be applied to a living body, including, but not limited to, toothpastes, acne creams, hand soaps, mouthwashes, anti-wrinkle creams, and blemish creams. “Inanimate object” cleansing refers to any type of cleansing vehicle that can be applied to inanimate objects, including, but not limited to, laundry detergents, carpet cleaners, surface cleaners, bathroom cleaners, pool cleaners, and various antimicrobial cleaners.

“Enzymes” refers to organic biological catalysts, typically comprising proteins, that facilitate reactions to proceed without extremes of temperature or pressure, and may be specific to certain reactants depending upon the type of enzyme. For the purposes of this application, the term enzyme shall be defined broadly to include any coenzyme that assists in the catalytic reaction, or enhances function of the enzyme.

“Coenzyme” refers to an organic or organometallic, usually non-peptide moiety integrated with an enzyme, that allows it to function or enhances function. Glucose oxidase, for instance, incorporates a flavine adenine dinucleotide (FAD) coenzyme that participates in the reaction:

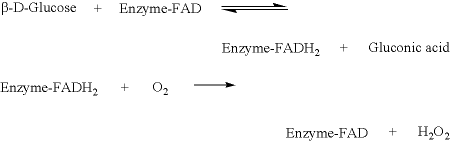

Gluconic acid is also known as δ-D-gluconolactone. In the above reaction process, Glucose oxidase incorporates a flavine adenine dinucleotide (FAD) coenzyme that participates in the reaction as previously described. It can be seen from the coenzyme equations that 1 mole of glucose (180 g) will be needed to consume 1 mole of oxygen (32 g). Since 1 mole of a gas occupies 22.41383 liters at 273.15K and 101325 N.m⁻², 1 g of glucose is enough to consume 124.52 cm³ of oxygen.

“Substrates” refers to the reactant or reactants upon which an enzyme acts. Substrates may be specific to particular enzymes. Substrates bind with enzymes to form an intermediate enzyme-substrate complex. In this way, enzymes control the speed and specificity of biochemical reactions.

“Donor Substrate” refers to a reactant that becomes at least partially oxidized when acted upon by an enzyme. For example, when utilizing glucose oxidase enzyme, glucose would be an acceptable donor substrate (i.e., it is specific to the glucose oxidase enzyme) because glucose is oxidized to gluconic acid by oxygen in the presence of glucose oxidase.

“Acceptor Substrate” refers to a substrate that reacts with the donor substrate in an enzyme mediated reaction to become at least partially reduced. For example, in the combination of glucose, oxygen, and glucose oxidase, oxygen would be considered an acceptor substrate because it is reduced to hydrogen peroxide.

“Biocide” refers to a substance that kills microbes or microorganisms.

“Biostat” refers to a substance that prevents microbes from multiplying/reproducing.

“Stain” refers to a discoloration, typically by foreign matter. Some examples of stains include, but are not limited to, grass stains; wine stains; fruit juice stains, such as cranberry, orange, blackberry, raspberry, blackcurrant, blueberry, and carrot; lily flower pollen; tobacco smoke stains; engine oil stains (due to the presence of complex polycyclic materials); sweat and grime stains on shirt collars and cuffs; mold and mildew stains; walnut fruit stains which may cause a brown stain; tea and coffee stains which contain materials that produce a brown stain; onion juice stain which may cause a yellow stain; naturally occurring stains from plants which may contain many different compounds, including betain (red colorant in grape skins, beetroot,) or similar materials (the deep red color of some of these materials may be attributed to cyanine chromophores); the chlorophylls which may give blue to green stains and also orange to yellow stains due to beta-carotene, beta-apocarotenal, and other polyene type chromophores present in plant chlorophyll (carrot juice, tomato juice, etc); stains from animals such as cochineal (a red anthraquinone based colorant) from the cochineal beetle; insect droppings from spiders, cockroaches, etc. which may cause brown stains; blood which causes a reddish brown stain due to the presence of hemoglobin; insect droppings from blood sucking organisms which may cause reddish stains, for instance flea droppings, which cause a reddish brown stain when they are moistened on fabric; animal bowel movements which are in any case malodorous (the brown color of mammalian bowel movements is primarily due to a combination of the color of the food ingested, products of the reductive metabolism of chromophores present in the food by intestinal fauna, and bile secreted into the duodenum from the gall bladder which contains metabolized hemoglobin); mammalian urine stains which contains colored compounds that may cause stains on clothes and offensive odors in the home; and felt tip coloring pen and ink stains, which contain a range of chromophones such as triphenylmethane, azo, hydrazo, diphenylmethane, hydrazone, and xanthene, which may cause stains on rugs and fabrics.

“Aqueous” refers to a substance being made from, with, or by means of water.

“Stabilizer” refers to a substance or combination of substances that can preserve the activity of an enzyme over time under various conditions. There are inherent problems with enzyme compositions. For example, for purposes of this invention, it is desirable in some cases to have an aqueous enzyme composition. However, enzymes may be denatured in water over time, resulting in a loss of enzymatic activity. Thus, in order to have an aqueous enzyme composition that is suitable for the invention, it is desirable that the enzyme be stabilized so that it can retain its activity for long periods of time.

“Instrument” refers to an object that can apply or effectuate a cleansing vehicle of the invention.

“Cleansing composition” shall be used interchangeably with “Cleansing product” and shall mean the total formulation of the substance used in accordance with the invention to clean.

These terms may be defined with additional language in the remaining portions of the specification.

### DETAILED DESCRIPTION OF THE INVENTION

The present invention provides a method for generating hydrogen peroxide within a cleansing vehicle by use of a cleansing composition. The formulation of the cleansing composition includes at least the following components: 1) a cleansing vehicle; 2) an enzyme capable of catalyzing the production of hydrogen peroxide from a gaseous acceptor substrate, the enzyme associated with or contained within the cleansing vehicle; and 3) a donor substrate specific to the particular enzyme, the donor substrate associated with or contained within the cleansing vehicle.

A cleansing vehicle is a substance that can be used, inter alia, for cleaning, whitening, brightening, and antimicrobial activity. For example, one such use envisioned by the invention is for removing stains, such as from teeth, carpeting, clothing and counter tops. In another example, the cleansing vehicle may be used for control of antimicrobial activity, such as for killing germs inside a mouth. In still another example, the cleansing vehicle may be used for oxidizing acne causing bacteria on human skin.

Cleansing vehicles include, but are not limited to, laundry detergents, carpet cleaners, hand soaps, mouthwashes, skin creams, anti-wrinkle creams, blemish creams, toothpastes, surface cleaners, bathroom cleaners, antimicrobial cleaners, and pool cleaners. Descriptions of some useful cleansing vehicles may be found in, for example, U.S. Pat. No. 4,318,818 for “Stabilized Aqueous Enzyme Composition,” U.S. Pat. No. 5,916,862 for “Detergent Compositions Containing Amines and Anionic Surfactants,” U.S. Pat. No. 5,942,482 for “Acaricidal Carpet Cleaning Composition Comprising Esterified and Non-Esterified Ethoxylated Glycerol Mixture,” U.S. Pat. No. 6,147,039 for “Antibacterial Liquid Hand Cleaning Compositions Containing a Hydroxy Containing Organic Acid,” U.S. Pat. No. 5,891,422 for “Antimicrobial Composition Containing a C₃-C₆ Alcohol,” U.S. Pat. No. 5,348,943 for “Cosmetic and Skin Treatment Compositions,” U.S. Pat. No. 4,885,155 for “Anticalculus Compositions Using Pyrophosphate Salt,” U.S. Pat. No. 6,303,557 B1 for “Fast Acting Disinfectant and Cleaner Containing Biguanidine,” U.S. Pat. No. 6,303,046 for “All Purpose Liquid Bathroom Cleaning Compositions,” U.S. Pat. No. 5,911,915 for “Antimicrobial Multi Purpose Microemulsion,” U.S. Pat. No. 5,994,283 for “Liquid Cleaning Compositions Compressing a Negatively Charged Complex of an Anionic and Zwitterionic Surfactant,” and U.S. Pat. No. 6,200,941 for “Fully Diluted Hard Surface Cleaners Containing High Concentrations of Certain Anions,” the contents all of which are incorporated herein by reference in their entirety. The cleansing vehicles are typically aqueous in nature, although the invention can properly function in certain non-aqueous environments as well.

Generally speaking, enzymes are specific proteins that act as catalysts for certain chemical reactions. Most of these reactions would not otherwise proceed in a reasonable time without extreme temperature or pressure. Furthermore, enzymes may be specific for the substrates upon which they act. The enzymes used in the invention catalyze reactions by facilitating oxidation of donor substrates while simultaneously facilitating reduction of acceptor substrates.

The invention specifically contemplates use of enzymes that have the capability of producing hydrogen peroxide by catalyzing reactions within a cleansing vehicle that contains or has associated therewith a donor substrate specific to the particular enzyme (which is likewise associated or contained in the composition), and which enzymes have access to an acceptor substrate, either contained in the composition or through exposure via the environment, i.e., air or oxygen, or dissolved air or oxygen. One such class of enzymes contemplated by the invention, for example, is oxidase, which utilizes gaseous oxygen as an acceptor substrate. Examples of such enzymes include, but are not limited to, (S)-2-hydroxy-acid oxidase, malate oxidase, glucose oxidase, hexose oxidase, cholesterol oxidase, aryl-alcohol oxidase, L-gulonolactone oxidase, galactose oxidase, pyranose oxidase, L-sorbose oxidase, pyridoxine 4-oxidase , alcohol oxidase, (S)-2-hydroxy-acid oxidase, ecdysone oxidase, choline oxidase, secondary-alcohol oxidase, 4-hydroxymandelate oxidase, glycerol-3-phosphate oxidase, xanthine oxidase, thiamin oxidase, L-galactonolactone oxidase, cellobiose oxidase, hydroxyphytanate oxidase, N-acylhexosamine oxidase, polyvinyl-alcohol oxidase, methanol oxidase, D-arabinono-1,4-lactone oxidase, vanillyl-alcohol oxidase, nucleoside oxidase (H₂O₂-forming), D-mannitol oxidase, xanthine oxidase, pyruvate oxidase, oxalate oxidase, glyoxylate oxidase, pyruvate oxidase (CoA-acetylating), aryl-aldehyde oxidase, carbon-monoxide oxidase, retinal oxidase, dihydroorotate oxidase, lathosterol oxidase, acyl-CoA oxidase, dihydrouracil oxidase, and tetrahydroberberine oxidase. These enzymes are presented merely as examples and are not meant to be exhaustive or limiting in any manner.

Donor substrates may be specific to the particular enzyme utilized. For example, if glucose oxidase enzyme is selected, then glucose would be an acceptable donor substrate. In another example, if polyvinyl-alcohol oxidase enzyme is selected, then polyvinyl alcohol would be an acceptable donor substrate. In still another example, if galactose oxidase enzyme is selected, then galactose would be an acceptable donor substrate. Thus, keeping in mind the aforementioned enzyme examples, the following respective donor substrates would be acceptable for use in the invention: (S)-2-hydroxy acid, (S)-malate, glucose, β-D-glucose, cholesterol, an aromatic primary alcohol, L-gulono-1,4-lactone, D-galactose, D-glucose, L-sorbose, pyridoxine, a primary alcohol, (S)-2-hydroxy acid, ecdysone, choline, a secondary alcohol, (S)-2-hydroxy-2-(4-hydroxyphenyl)acetate, sn-glycerol 3-phosphate, xanthine, thiamine, L-galactono-1,4-lactone, cellobiose, L-2-hydroxyphytanate, N-acetyl-D-glucosamine, polyvinyl alcohol, methanol, D-arabinono-1,4-lactone, vanillyl alcohol, adenosine, mannitol, xanthine, pyruvate+phosphate, oxalate, glyoxylate, pyruvate+CoA, an aromatic aldehyde, carbon monoxide and water, retinal, (S)-dihydroorotate, 5α-cholest-7-en-3β-ol, acyl-CoA, 5,6-dihydrouracil, and (S)-tetrahydroberberine. These donor substrates are presented merely as examples and are not meant to be exhaustive or limiting in any manner.

The acceptor substrate of the invention is contemplated to include at least oxygen. Oxygen can be utilized in a number of forms, such as, for example, pure oxygen, oxygen mixed with other molecules to form air, oxygen mixed with carbon dioxide such as in a mouth, and oxygen dissolved in a cleansing vehicle. The acceptor substrate is not meant to be limited to these examples, but rather can encompass any molecule or form that can be used with a corresponding enzyme and donor substrate to generate hydrogen peroxide.

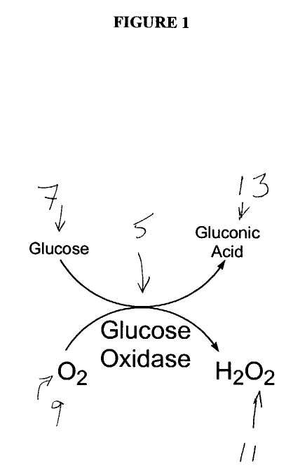

One aspect of the invention can be seen in FIG. 1, which illustrates a schematic of the chemical reaction for generation of hydrogen peroxide in situ.

In this Figure, a hypothetical cleansing vehicle is contemplated that contains glucose oxidase 5 as the enzyme, glucose 7 as a donor substrate, and oxygen 9 as an acceptor substrate. The resulting reaction produces hydrogen peroxide 11, with gluconic acid 13 as a byproduct.

In order to increase/enhance the efficacy of a cleansing vehicle utilizing such reaction, with regard to certain focal objects, it may be desirable to enhance the oxidizing capabilities of the cleansing vehicle to obtain a bleaching effect. Therefore, it is a further objective of the invention to, in certain instances, convert the hydrogen peroxide, produced as described above, into water which can result in oxidative bleaching. This objective can be accomplished through the use of an additional enzyme in the cleansing vehicle, that has the is capability of converting hydrogen peroxide into water. In this embodiment, the reaction to produce hydrogen peroxide would proceed as described above in FIG. 1. Once the hydrogen peroxide has been formed, it becomes an acceptor substrate itself so that an additional enzyme can then utilize an existing donor substrate, such as a stain, to catalyze a reaction, resulting in an oxidative bleaching effect. One such second enzyme contemplated by the invention, for example, is peroxidase.

Further examples of such additional enzymes include, but are not limited to, lactoperoxidase, bromoperoxidase and microperoxidase. Acceptable donor substrates for peroxidase enzymes include, but are not limited to, phenols, aromatic amines, pyrogallol, guaiacol, ferrocyanide, 4-aminoantipyrine and cyctochrome c. These enzymes and substrates are presented merely as examples and are not meant to be exhaustive or limiting in any manner.

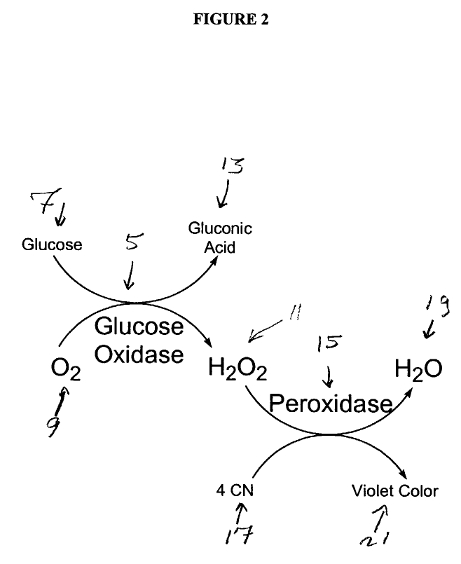

This aspect of the invention with enhanced oxidizing efficacy can be seen in FIG. 2, which illustrates a schematic of the chemical reaction for the generation of hydrogen peroxide in situ and the subsequent conversion to water utilizing 4-chloro-1-naphthol (4CN) indicator as a peroxidase substrate to effect a color change. In this example, a hypothetical cleansing vehicle contains glucose 7, 4-chloro-1-naphthol indicator 17, glucose oxidase enzyme 5, and a peroxidase enzyme 15. When the cleansing vehicle is exposed to oxygen 9, either within the vehicle or through external sources, the reaction initiates. In the first reaction stage, the glucose oxidase 5 utilizes the glucose 7 and oxygen 9 to catalyze a reaction, forming hydrogen peroxide 11. In the second reaction stage, the peroxidase enzyme 15 utilizes the hydrogen peroxide 11 and 4-chloro-1-naphthol indicator substrate 17 to catalyze a reaction, forming water 19 and a violet color 21. Here, the formation of the violet color from the reaction with 4-chloro-1-naphthol indicates that the intended objective of the invention indeed occurs.

It is recognized in the field of the art that enzymes tend to be unstable in that their degree of activity can diminish over time. Therefore it is a further objective of the invention to utilize stabilizers to counteract this effect. Generally speaking, a stabilizer has the ability to help maintain the degree of activity of an enzyme over time without interfering in the catalytic reaction process. Stabilizers will typically, although not necessarily, be added to the cleansing vehicle at the same time that the enzymes are added. It is known in the art that stabilizers may be specific to particular enzymes, and effectiveness may be further influenced by concentration. For example, Bovine Serum Albumin (BSA) is a protein that is commonly used to stabilize enzymes; however, other agents such as, for example, certain sugars, salts (such as calcium salts), carboxylic acids and polyhydric alcohols may also be effective. Other examples of stabilizers may include surfactants within a certain concentration range, and electrolytes. These stabilizers are presented merely as examples and are not meant to be exhaustive or limiting in any manner.

It is also recognized in the field of the art that enzyme function is dependent upon pH. Enzymes usually have an optimum pH range in which they operate most effectively to catalyze a given reaction. Thus, it may be desirable to add pH buffers, such as sodium citrate, trisodium phosphate, disodium hydrogen phosphate, sodium dihydrogen phosphate, sodium or potassium acetates, acetic acid, citric acid, hydrochloric acid, sodium hydroxide, and the like to the cleansing vehicle.

It is also recognized in the field of the art that cleansing vehicles may be subject to microbial growth over time. This is of particular concern when the focal object on which the cleansing vehicle is to be used is a bodily part. Therefore, it is a further objective of the invention to utilize preservatives within the cleansing vehicle to counteract this effect. Preservatives contemplated by the invention include biocides and biostats. Generally speaking, biocides kill microbes while biostats prevent microbes from multiplying. Examples of preservatives that can be utilized with the invention include, but are not limited to, ethanol, isopropanol, benzoic acid, sodium nitrite, sodium nitrate, and ethylenediaminetetraacetic acid (EDTA) or the sodium salt thereof; eugenol, thymol, and eucalyptol, which are naturally occurring phenolic preservatives; and Proxel GXL (for basic formulations) and Proxel DB-20 (for acidic formulations), which are commercially available from Avecia Inc. of Wilmington, Del. and are effective against bacterium, molds and yeasts. These preservatives are presented merely as examples and are not meant to be exhaustive or limiting in any manner.

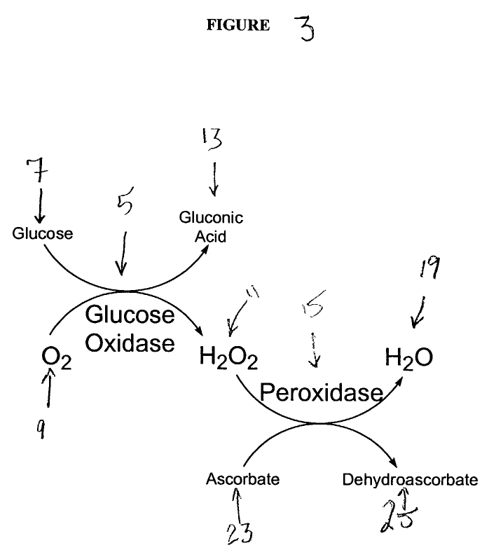

In another aspect of the invention, a hypothetical cleansing vehicle includes at least two enzymes that cooperatively produce and remove hydrogen peroxide using a catalytic reaction mechanism along with other materials. For instance, as seen in FIG. 3, glucose oxidase enzyme 5 catalyzes a reaction between glucose 7 and oxygen 9 to form hydrogen peroxide 11. A peroxidase enzyme 15 then catalyzes a reaction between the hydrogen peroxide 11 and ascorbate 23 to produce water 19, with dehydroascorbate 25 as a byproduct. Here, the glucose 7 and the ascorbate 23 function as donor substrates, and the oxygen 9 and the hydrogen peroxide 11 function as acceptor substrates.

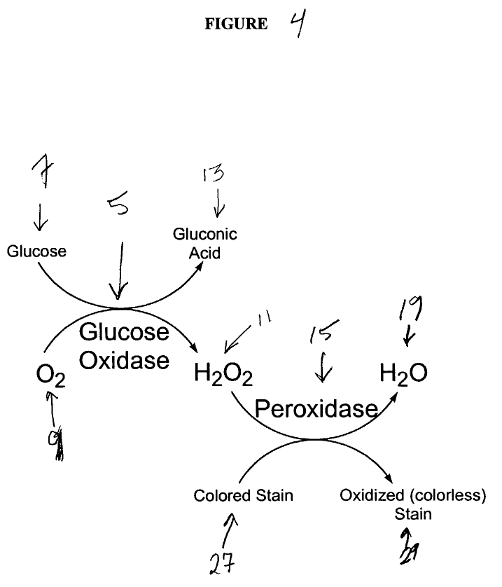

In another aspect of the invention a hypothetical cleansing vehicle includes at least two enzymes that cooperatively produce hydrogen peroxide and use it to oxidize a stain. For instance, as seen in FIG. 4, glucose oxidase enzyme 5 catalyzes a reaction between glucose 7 and oxygen 9 to form hydrogen peroxide 11. A peroxidase enzyme 15 then catalyzes a reaction between the hydrogen peroxide 11 and a colored stain 27 to produce water 19 and an oxidized (colorless) stain 29. Here, the stain acts as a donor substrate while the hydrogen peroxide acts as an acceptor substrate for the peroxidase enzyme mediated reaction. The stain is bleached by oxidation in the process.

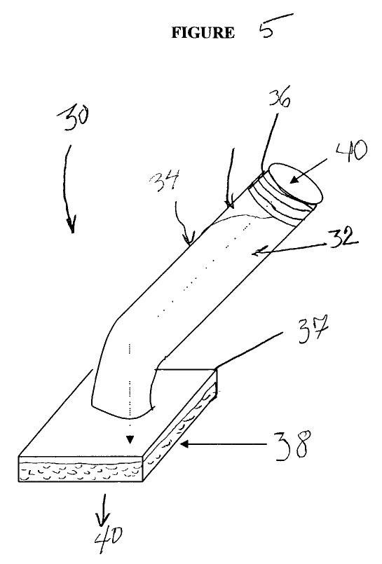

The present invention can be utilized through a number of dispensing instruments designed to apply or effectuate a cleansing vehicle containing the enzymes. For example, as can be seen in FIG. 5, a dispenser 30 contains the cleansing vehicle 32. In particular, the cleansing vehicle 32 containing the enzymes in accordance with the invention, is added to the storage chamber 34 of the instrument through a removable screw-on top 36. A mounting bracket 37 is disposed at the end of the storage chamber 34 for holding a scrubber sponge 38. The cleansing vehicle 32 is dispersed into the scrubber sponge 38 during use along path 40 illustrated by the dotted arrow. In particular, as pressure is maintained on the scrubber sponge during a cleaning operation, the pressure and release of pressure draws the cleansing vehicle out of the scrubber sponge 38. Oxygen in the air surrounding the scrubber sponge 38, and within the sponge itself is introduced to the cleansing vehicle either within the sponge, at the point of contact of the scrubbing sponge to the object to be cleaned, or alternatively, in the storage compartment of the instrument. Scrubbing action during use exposes the cleansing vehicle to additional oxygen from the surrounding air, thereby initiating the enzyme mediated reaction.

Such an instrument could be used for, inter alia, washing dishes or other household items. Other examples of such dispensers include, but are not limited to, a toothbrush with a cleansing vehicle dispensing chamber, a scrub brush with a dispensing chamber, a squeeze tube, a washing machine, a dish washer, a spray bottle, a shampoo vacuum, rag, and a wash cloth. The cleansing vehicle of the invention may itself, depending on its formulation, be used to clean hands, fingers, and mouth areas. Again, these instruments and objects to be cleaned are presented merely as examples, and are not meant to be exhaustive or limiting in any manner.

It should be recognized that the various components of the cleansing compositions of the invention need not be added at the same time. In particular, the components may be added to the cleansing composition prior to the end-use of the cleansing composition or during end-use. For instance, a gaseous acceptor substrate may be added in the original formulation or during end-use. In one embodiment, it is contemplated that the formulation is only exposed to air or oxygen during product use, such as during a cleaning operation, through routine exposure of the cleansing composition to air in the environment or through the body respiration process.

An exemplary formula for a cleansing-like vehicle illustrates the present invention.

### EXAMPLE 1

A cleansing-like vehicle comprising the present invention was formulated in accordance with the components in Table 1(a) and detailed in the following description.

TABLE 1(a)
Cleansing-like Vehicle

| COMPOUND | QUANTITY |
|---|---|
| Deionized water | 156.50 g |
| 2-pyrrolidone | 12.00 g |
| Tripropyl methyl glycol ether | 10.00 g |
| Polyethylene glycol 600 | 20.60 g |
| Proxel GXL (biocide) | 0.60 g |

The cleansing-like vehicle was formulated by combining 156.50 grams of deionized water, 12.00 grams of 2-pyrrolidone (available from Aldrich Chemical Co Inc. of Milwaukee, Wis.), 10.00 grams of tripropyl methyl glycol ether (available from Gallade Chemical Inc., of Santa Ana, Calif.), 20.60 grams of polyethylene glycol 600 (poly(ethylene glycol) with a molecular weight of approximately 600) is available from Aldrich Chemical Co Inc. of Milwaukee, Wis.), and 0.60 grams of Proxel GXL biocide (available from Avecia Inc. of Wilmington, Del.).

An indicator solution for hydrogen peroxide was also formulated in accordance with the components in Tables 1(b) and 1(c) and detailed in the following description.

TABLE 1(b)
Buffered 5 mM Glucose Solution

| COMPOUND | CONCENTRATION |
|---|---|
| Na₂HPO₄ | 50 mM |
| Citric Acid | 25 mM |
| Sodium Chloride | 50 mM |
| Glucose | 5 mM |

Disodium hydrogen phosphate (available from Sigma-Aldrich of Milwaukee, Wis.) was dissolved in deionized water. Citric acid and sodium chloride (both available from Sigma-Aldrich of Milwaukee, Wis.) were added to give the concentrations given in Table 1(b). This solution gave a pH of 5.00. The glucose solution was stored overnight at 4° C. to effect mutarotation of the glucose.

TABLE 1(c)
Indicator Solution

| COMPOUND | QUANTITY | |
|---|---|---|
| Buffered 5 mM glucose solution | 15 | ml |
| Peroxidase enzyme (activity: 150-250 units per mg) | 1 | mg |
| Agitate to dissolve enzyme | | |
| 4-chloro-1-naphthol (4CN) solution | 1 | ml |

The indicator solution for hydrogen peroxide was formulated by dissolving 1 milligram of peroxidase enzyme (Type 2, from horseradish, available from Sigma-Aldrich of Milwaukee, Wis.) into 15 milliliters of buffered 5 mM glucose solution, Table 1(b). To this mixture, 1 milliliter of 4-chloro-1-naphthol peroxidase substrate solution (4CN) (available from Kirkegaard and Perry Labs from Gaithersburg, Mass.) was added. Peroxidase enzyme facilitates oxidization of the 4CN substrate to a violet colored compound in the presence of hydrogen peroxide.

To demonstrate the invention, 0.6 milliliters of deionized water was mixed with 1.4 milliliters of the cleansing-like vehicle, and 0.4 milliliters of indicator solution was added. Under these conditions, no color developed, indicating that hydrogen peroxide was not present in the cleansing-like vehicle.

Subsequently, 1.4 milliliters of the cleansing-like vehicle was combined with 0.6 milliliters of 1 milligram/milliliter glucose oxidase solution (activity 166,000 units/mg) (type X-S from Aspirgillis Niger, Sigma, St. Louis Md.). When 0.4 milliliters of indicator solution was added, an immediate purple color developed, indicating that hydrogen peroxide was being produced in the solution. This reaction can be seen in FIG. 2. In addition, the purple color indicated that the peroxidase enzyme was also operating in the solution. Moreover, it suggested that dissolved oxygen was being converted into hydrogen peroxide, and then into water in situ.

The present invention is further illustrated by comparisons of several existing cleansing vehicles (as described in US patents) to the same vehicles (although prophetic) incorporating the invention in various aspects, as seen in the following set of examples. In each of the examples, the references to Figure numbers, refer to a composition formulation which includes the components necessary to carry out the reaction described in the figure. Such components either include oxygen/air itself so as to enable the reaction to proceed independently, or alternatively, allow for the carrying out of the reaction upon exposure to oxygen/air through a cleaning operation using such cleansing vehicle.

### EXAMPLE 2

The cleansing vehicle in this example is directed towards a liquid laundry detergent. Materials are to be added in the order shown. Concentrations are in percentages by weight.

TABLE 2

| LIQUID LAUNDRY | | | | |
|---|---|---|---|---|
| DETERGENT | | | | |
| (ADAPTED FROM | | | | |
| U.S. Pat. No. | | | | |
| 4,318,818, | | | | |
| INCORPORATED BY | ADAPTED | | | |
| REFERENCE | FROM | EMBODI- | EMBODI- | EMBODI- |
| HEREIN) | 4,318,818 | MENT 1 | MENT 2 | MENT |
| Water | 20 | 20 | 20 | 20 |
| n-dodecyl benzene | 14 | 14 | 14 | 14 |
| sulfonic acid | | | | |
| condensation product | 15 | 15 | 15 | 15 |
| of 1 mole C₁₃-C₁₅ | | | | |
| oxo-alcohol and 7 | | | | |
| moles ethylene oxide | | | | |
| (non-ionic surfactant) | | | | |
| Hardened and topped | 10 | 10 | 10 | 10 |
| coconut fatty acid | | | | |
| Oleic Acid (85% | 5 | 5 | 5 | 5 |
| purity) | | | | |
| Sodium Hydroxide | 1.75 | 1.75 | 1.75 | 1.75 |
| Ethanol | 10 | 10 | 10 | 10 |
| 1,2-propane diol | 4 | 4 | 4 | 4 |
| Triethanolamine to | (variable) | (variable) | (variable) | (variable) |
| adjust to pH 7 | | | | |
| Sodium Formate | 1 | 1 | 0 | 1 |
| Calcium Chloride | 0 | 0.005 | 0.005 | 0.005 |
| Alkaline proteolytic | 0.05 | 0 | 0 | 0 |
| enzyme* | | | | |
| Glucose Oxidase | 0 | 0.05 | 0.05 | 0.05 |
| Enzyme | | | | |
| Glucose | 0 | 1 | 1 | 1 |
| Peroxidase Enzyme | 0 | 0 | 0 | 0.05 |
| Diethylene triamine | 0.3 | 0.3 | 0.3 | 0.3 |
| pentamethylene | | | | |
| phosphonic acid | | | | |
| Proxel GXL Biostat | 0 | 0.3 | 0.3 | 0.3 |

| | |
|---|---|
| Silicone Suds Regulant | Balance to make up to 100% |
| Emulsion** | |
| Perfume** | |
| Opacifier** | |
| Brightener** | |
| Dye** | |
| Water | |

*Already contains calcium ions as supplied.
**Effective dose varies according to nature of agent and level of control desired.

In this example, The FIG. 1 embodiments 1 and 2 would generate hydrogen peroxide in situ with agitation of cleaning, and the FIG. 4 embodiment, would generate hydrogen peroxide in situ coupled with peroxidase-assisted bleaching.

### EXAMPLE 3

The cleansing vehicle in this example is directed towards a carpet cleaner. All ingredients are given in percent by weight. Ingredients would be added in the order shown, with stirring. Optionally, a degassing step could be included to remove oxygen before addition of the glucose oxidase enzyme. Sodium C₁₃-C₁₇ Paraffin Sulfonate, and Levenol F-200 are both surfactants, that allow the cleaner to wet out on the carpet by reducing the surface tension of the fluid and allow grease and dirt to be washed away. Diethylene glycol monobutyl ether is a glycol which also helps remove dirt and also helps to wet out the carpet. Calcium chloride acts as a stabilizer for the enzymes used. An acaricidal agent may also be added to control dust mites that can cause allergic reactions in some people. Proxel GXL is a biostat that controls the growth of microbes that may want to feed on the glucose in the formulation.

TABLE 3

| CARPET CLEANER | | | |
|---|---|---|---|
| FORMULAS ADAPTED FROM | | | |
| U.S. Pat. No. 5,942,482 | ADAPTED | | |
| INCORPORATED BY | FROM | EMBODI- | EMBODI- |
| REFERENCE HEREIN | 5,942,482 | MENT | MENT |
| Water | 50 | 50 | 50 |
| Sodium C₁₃-C₁₇ Paraffin Sulfonate | 4.7 | 4.7 | 4.7 |
| Levenol F-200 (ethoxylated | 2.3 | 2.3 | 2.3 |
| glycerol) | | | |
| Diethylene glycol monobutylether | 4 | 4 | 4 |
| Magnesium sulfate heptahydrate | 2.2 | 2.2 | 2.2 |
| Perfume | 0.8 | 0.8 | 0.8 |
| Calcium Chloride | 0 | 0.005 | 0.005 |
| Acaricidal agent (dust mite killer, | ** | ** | ** |
| optional, may also be perfume) | | | |
| Glucose | 0 | 1 | 1 |
| Peroxidase | 0 | 0 | 0.05 |
| Proxel GXL | 0 | 0.3 | 0.3 |
| Sodium Formate | 0 | 1 | 1 |
| Water | Balance to 100% | | |
| Glucose Oxidase | 0 | 0.05 | 0.05 |

**effective dose varies according to nature of agent and level of control desired.

In this example, the FIG. 1 embodiment would generate hydrogen peroxide in situ with agitation of cleaning, and the FIG. 4 embodiment would generate hydrogen peroxide in situ coupled with peroxidase assisted bleaching.

### EXAMPLE 4

The cleansing vehicle in this example is directed towards a hand and body lotion. In separate containers, the ingredients of phase A are thoroughly mixed and the ingredients of phase B are heated to 75° C. Phase A is poured into phase B and mixed well at room temperature for 10 minutes. The mixture is removed from the heat and mixed until the temperature is under 40° C. Phase C ingredients are then added in the order listed, and the mixture is blended well between additions. Lastly, the pH is then adjusted to 6. The mixture could be optionally degassed prior to adding the enzyme package.

TABLE 4

| HAND AND BODY LOTION | | | |
|---|---|---|---|
| ADAPTED FROM | ADAPTED | | |
| PUBLISHED FORMULARY | FROM | EMBODI- | EMBODI- |
| IN HAPPI.COM | HAPPI.COM | MENT | MENT |
| Phase A | | | |
| Varisoft TA-100 (Goldschmidt, | 4.75 | 4.75 | 4.75 |
| distearyldimonium chloride) | | | |
| Crodacol C-70 (Croda, Cetyl | 2.00 | 2.00 | 2.00 |
| alcohol) | | | |
| Snow White Petrolatum | 4.00 | 4.00 | 4.00 |
| (Penreco, Petrolatum) | | | |
| D.C. Fluid 200 (Dow Corning, | 0.25 | 0.25 | 0.25 |
| Dimethicone) | | | |
| Phase B | | | |
| Deionized Water | To total 100 parts | | |
| Stepan IPM (Stepan, isopropyl | 3.25 | 3.25 | 3.25 |
| myristate) | | | |
| Glycerine | 4.00 | 4.00 | 4.00 |
| Calcium Chloride | 0 | 0.005 | 0.005 |
| Sodium formate | 0 | 1 | 1 |
| Phase C | | | |
| Sensomer CI-50 (Ondeo Nalco, | 3.00 | 3.00 | 3.00 |
| Starch hydroxypropyltrimonium | | | |
| chloride) | | | |
| AA040513 Cucumber | 0.25 | 0.25 | 0.25 |
| (Arylessence Inc., Fragrance) | | | |
| Preservative | ** | ** | ** |
| Sodium Hydroxide | *** | *** | *** |
| Optional degassing step to | No | Yes | Yes |
| remove dissolved oxygen | | | |
| Glucose Oxidase | 0 | 0.05 | 0.05 |
| Glucose | 0 | 1 | 1 |
| Peroxidase | 0 | 0 | 0.05 |
| Sodium Ascorbate | 0 | 0 | 1 |
| Optional: air sensitive | 0 | ** | ** |
| pharmaceutical | | | |

**effective dose varies according to agent used
***adjust to pH 6.0

In this example, the FIG. 1 embodiment would generate hydrogen peroxide on the skin for added antibacterial effect. The FIG. 3 embodiment would effectively remove oxygen from the formulation thus protecting any oxygen sensitive ingredient (such as a vitamin, a pharmaceutical, etc.) during storage.

### EXAMPLE 5

The cleansing vehicle in this example is directed towards a mouthwash. The composition may be prepared by adding the essential oils (thymol, eucalyptol, methyl salicylate, and menthol), poloxamer 407, and benzoic acid to ethanol, followed by the addition of 250 g potable water. Caramel, citric acid, sodium citrate, sorbitol, glucose, and peroxidase may then be added and mixed in, and enough water may be added to make the volume 1000 ml. Optionally, the mixture may be degassed to remove oxygen before adding the glucose oxidase.

TABLE 5

| MOUTHWASH FORMULAE | | | | | | |
|---|---|---|---|---|---|---|
| ADAPTED FROM U.S. Pat. No. | ADAPTED | | | | | |
| 5,891,422 INCORPORATED | FROM | | EMBODI- | | EMBODI- | |
| HEREIN BY REFERENCE | 5,891,422 | | MENT | | MENT | |
| Ethanol | 227 | ml | 227 | ml | 227 | ml |
| Thymol | 0.66 | g | 0.66 | g | 0.66 | g |
| Eucalyptol | 0.92 | g | 0.92 | g | 0.92 | g |
| Menthol | 0.43 | g | 0.43 | g | 0.43 | g |
| Methyl Salicylate | 0.66 | g | 0.66 | g | 0.66 | g |
| Benzoic Acid | 1.5 | g | 1.5 | g | 15 | g |
| Caramel | 0.24 | g | 0.24 | g | 0.24 | g |
| Poloxamer 407 (poly(oxyethylene)- | 0.5 | g | 0.5 | g | 0.5 | g |
| poly(oxypropylene) non-ionic | | | | | | |
| surfactant) | | | | | | |
| Citric Acid | 0.1 | g | 0.1 | g | 0.1 | g |
| Sodium Citrate | 0.3 | g | 0.3 | g | 0.3 | g |
| Sorbitol | 250 | g | 250 | g | 250 | g |
| Glucose | 0 | | 10 | g | 10 | g |
| Peroxidase | 0 | | 0 | | 0.5 | g |
| Potable Water | Make up to 1 liter | | | | | |
| Glucose Oxidase | 0 | | 0.5 | g | 0.5 | g |

In this example, the embodiment from FIG. 1 would generate hydrogen peroxide while gargling, and the embodiment from FIG. 4 would generate hydrogen peroxide coupled with peroxidase assisted bleaching for removing stains from teeth and the tongue.

### EXAMPLE 6

The cleansing vehicle in this example is directed towards a toothpaste. In this example, water and part of the sorbitol solution are combined and heated to 140° F. The Na₂H₂P₂O₇, Na₄P₂O₇, saccharin, sodium fluoride, and precipitated silica is then added order and the mixture is agitated for 5-10 minutes. Flavor, dye and surfactant are then added. In a separate vessel, the remainder of the sorbitol, the Carbopol and the xanthan gum are slurried together and added to the main mix tank. The completed batch is then mixed further for one-half hour, subsequently milled and deaerated. Optionally, the enzyme would be added after deaeration.

TABLE 6

| TOOTHPASTE FORMULA EXAMPLES | ADAPTED | |
|---|---|---|
| ADAPTED FROM U.S. Pat. No. 4,885,155 | FROM | EMBODI- |
| INCORPORATED HEREIN BY REFERENCE | 4,885,155 | MENT |
| Distilled water | 16.484 | 15.684 |
| Sorbitol (as a 70% sorbitol solution) | 49.563 | 49.563 |
| (humectant) | | |
| Sodium saccharin (sweetener) | 0.3 | 0.3 |
| Dye solution | 0.35 | 0.35 |
| Precipitated silica (dental abrasive) | 20.00 | 20.00 |
| Sodium Fluoride | 0.243 | 0.243 |
| Flavor | 1.330 | 1.330 |
| Sodium alkyl sulfate (as 27% aq solution) | 5.000 | 5.000 |
| (sudsing agent) | | |
| Carbopol 940S (water soluble polymer) | 0.180 | 0.180 |
| Xanthan Gum (binder) | 0.600 | 0.600 |
| Na₄P₂O₇ | 2.400 | 2.400 |
| Na₂H₂P₂O₇ | 1.190 | 1.190 |
| K₄P₂O₇ (63.5% aq solution) | 2.360 | 2.360 |
| Glucose | 0 | 0.750 |
| Glucose Oxidase | 0 | 0.050 |

In this example, the FIG. 1 embodiment would generate hydrogen peroxide while brushing. Any glucose in the mouth would be oxidized by glucose oxidase to generate hydrogen peroxide, preventing oral bacterial growth.

### EXAMPLE 7

The cleansing vehicle in this example is directed towards a hand soap. This example is prepared through simple mixing of the ingredients in the order listed. Quantities are given in % weight

TABLE 7

| HAND SOAP FORMULA ADAPTED FROM | ADAPTED | |
|---|---|---|
| U.S. Pat. No. 6,147,039 INCORPORATED | FROM | EMBODI- |
| HEREIN BY REFERENCE | 6,147,039 | MENT |
| Water | 60.76 | 59.169 |
| Preservative | 0.2 | 0.2 |
| SLES Naturel (surfactant) | 30 | 30 |
| Cocamidopropyl Betaine (Zwitterionic | 4.8 | 4.8 |
| Surfactant) | | |
| Chestnut Leaves Extract | 0.1 | 0.1 |
| Perfume Apollo | 0.3 | 0.3 |
| Orthohydroxybenzoic Acid (anti-bacterial) | 0.51 | 0.51 |
| Dye | 0.8 | 0.8 |
| Sodium Hydroxide | 0.2 | 0.2 |
| Sodium Chloride | 2.33 | 2.33 |
| Sodium Formate | 0 | 0.5 |
| Calcium Chloride | 0 | 0.005 |
| Glucose | 0 | 1 |
| Glucose Oxidase | 0 | 0.05 |

The FIG. 1 embodiment would generate hydrogen peroxide during hand washing for purposes of cleansing and antimicrobial activity.

### EXAMPLE 8

The cleansing vehicle in this example is directed towards a bathroom cleaner. Percentages are by weight, and the ingredients are given in the order of addition. All ingredients are to be mixed until dissolved.

TABLE 8

| BATHROOM CLEANER FORMULA | | |
|---|---|---|
| EXAMPLE, ADAPTED FROM U.S. Pat. | ADAPTED | |
| No. 6,034,046 INCORPORATED BY | FROM | EMBODI- |
| REFERENCE HEREIN | 6,034,046 | MENT |
| Water | 94.6 | 93.55 |
| Cocomidopropyl betaine | 1.4 | 1.4 |
| Propyleneglycol n-butyl ether | 2.0 | 2.0 |
| Norasol 460ND (Norsohas, copolymer of | 2.0 | 2.0 |
| maleic anhydride and olefin (e.g. ethylene) | | |
| with a MW˜10,000 - this material acts to | | |
| prevent soap scum buildup) | | |
| Glucose | 0 | 1 |
| Glucose oxidase | 0 | 0.05 |
| Preservative | 0 | **** |

****optional

In this example, the FIG. 1 embodiment would generate hydrogen peroxide during scrubbing actions to help remove bio-films.

Although various embodiments of the invention have been described using specific terms, devices, and methods, such description is for illustrative purposes only. The words are words of description rather than of limitation. It is to be understood that changes and variations may be made by those of ordinary skill in the art without departing from the spirit or scope of the present invention, which is set forth in the following claims. In addition, it should be understood that aspects of the various embodiments may be interchanged either in whole or in part. Therefore, the spirit and scope of the appended claims should not be limited to the description of the exemplary versions contained therein.

We claim:

1. A method for generating hydrogen peroxide within a cleansing composition comprising the addition of at least one enzyme to a cleansing vehicle containing at least one donor substrate, wherein the enzyme catalyzes a chemical reaction to produce hydrogen peroxide upon exposure to a gaseous acceptor substrate.

2. The method of claim 1 wherein the cleansing vehicle comprises a liquid, a solid, or a mixture thereof.

3. The invention of claim 1 wherein the cleansing vehicle is aqueous.

4. The method of claim 1 wherein the enzyme is selected from the oxidase enzyme class.

5. The method of claim 1 wherein the donor substrate is at least glucose.

6. The method of claim 1 wherein the acceptor substrate comprises at least oxygen.

7. The method of claim 1 wherein the acceptor substrate is contained within the cleansing vehicle.

8. The method of claim 1 wherein the acceptor substrate is exposed to the cleansing vehicle during the cleansing composition end-use.

9. The method of claim 1 wherein the acceptor substrate is exposed to the cleansing vehicle through exposure to air.

10. The method of claim 1 wherein the acceptor substrate is exposed to the cleansing vehicle through bodily respiration.

11. The method of claim 1 further including the addition of at least one enzyme to the cleansing composition that can catalyze a reaction to convert hydrogen peroxide into water.

12. The method of claim 11 wherein the enzyme that can catalyze a reaction to convert hydrogen peroxide into water is selected from the peroxidase enzyme class.

13. The method of claim 1 further including the step of incorporating a stabilizer into said cleansing vehicle.

14. The method of claim 1 further including the step of incorporating a preservative into said cleansing vehicle.

15. The method of claim 1 wherein at least one enzyme is incorporated into the cleansing vehicle during the cleansing composition end-use.

16. The method of claim 1 wherein at least one donor substrate is incorporated into the cleansing vehicle during the cleansing composition end-use.

17. The method of claim 1 wherein at least one enzyme and one donor substrate are incorporated into the cleansing vehicle prior to the cleansing product end-use.

18. A method for generating hydrogen peroxide within a cleansing composition comprising the addition of at least one donor substrate, at least one enzyme, and at least one gaseous acceptor substrate to an aqueous cleansing vehicle, wherein the donor substrate is specific to the enzyme, wherein the acceptor substrate comprises oxygen or air, and wherein the enzyme catalyzes a chemical reaction to produce hydrogen peroxide upon exposure to the donor substrate and the gaseous acceptor substrate.

19. The method of claim 18 wherein the cleansing vehicle comprises a liquid, a solid, or a mixture thereof.

20. The method of claim 18 wherein the enzyme is selected from the oxidase enzyme class.

21. The method of claim 18 wherein the acceptor substrate is present within the cleansing vehicle.

22. The method of claim 18 wherein the acceptor substrate is exposed to the cleansing vehicle prior to the cleansing composition end-use.

23. The method of claim 18 wherein the acceptor substrate is exposed to the cleansing vehicle through exposure to air.

24. The method of claim 18 wherein the acceptor substrate is exposed to the cleansing vehicle through bodily respiration.

25. The method of claim 18 further including the addition of at least one enzyme to the cleansing product that can catalyze a reaction to convert hydrogen peroxide into water.

26. The method of claim 25 wherein the enzyme that can catalyze a reaction to convert hydrogen peroxide into water is selected from the peroxidase enzyme class.

27. The method of claim 18 further including the step of incorporating a stabilizer into said cleansing vehicle.

28. The method of claim 18 further including the step of incorporating a preservative into said cleansing vehicle.

29. The method of claim 18 wherein at least one enzyme is incorporated into the cleansing vehicle during the cleansing composition end-use.

30. The method of claim 18 wherein at least the donor substrate is incorporated into the cleansing vehicle during the cleansing composition end-use.

31. The method of claim 18 wherein at least the enzyme and the donor substrate are incorporated into the cleansing vehicle prior to the cleansing composition end-use.

32. A cleansing composition comprising:
a cleansing vehicle;
at least one enzyme;
at least one donor substrate;
wherein said at least one enzyme catalyzes a chemical reaction to produce hydrogen peroxide upon exposure to a gaseous acceptor substrate.

33. The cleansing composition of claim 32 further including a gaseous acceptor substrate.

34. The cleansing composition of claim 32 further including a stabilizer.

35. The cleansing composition of claim 32 further including a preservative.

36. The cleansing composition of claim 32 further including at least another enzyme that can catalyze a reaction to convert hydrogen peroxide into water

37. A cleansing composition comprising:
an aqueous cleansing vehicle;
at least one enzyme;
at least one donor substrate;
wherein the at least one donor substrate is specific to the at least one enzyme, and wherein the enzyme catalyzes a chemical reaction to produce hydrogen peroxide upon exposure to the donor substrate and a gaseous acceptor substrate.

38. The cleansing composition of claim 37 further including a gaseous acceptor substrate.

39. The cleansing composition of claim 37 further including a stabilizer.

40. The cleansing composition of claim 37 further including a preservative.

41. The cleansing composition of claim 37 further including at least another enzyme that can catalyze a reaction to convert hydrogen peroxide into water.
